(19) United States
(12) Patent Application Publication
(10) Pub. No.: US 2007/0263539 A1
(43) Pub. Date: Nov. 15, 2007

(54) Method For Monitoring Service Performance And Quality Level In A Telecommunications Network

(75) Inventors: Ulf Lonnqvist, Billdal (SE); Anders Bill, Sollentuna (SE); Staffan Ehnebom, Goteborg (SE); Per Sundin, Lund (SE)

Correspondence Address: ERICSSON INC., 6300 LEGACY DRIVE, M/S EVR 1-C-11, PLANO, TX, 75024, US

(73) Assignee: TELEFONAKTIEBOLAGET LM ERICSSON (PUBL), Stockholm (SE)

(21) Appl. No.: 11/575,111

(22) PCT Filed: Sep. 10, 2004
(86) PCT No.: PCT/SE04/01310

§ 371 Date: Mar. 12, 2007

(51) Int. Cl. H04L 12/26

(52) U.S. Cl. 370/232

(57) ABSTRACT

The invention discloses a method for monitoring service performance and quality level in a telecommunications network. The method comprises the use of Traffic Streams as the objects which are observed and used for said monitoring. The Traffic Streams are defined as objects which comprise: A Traffic Stream Type, which defines the nature of the traffic stream, A Traffic Source, which defines the origin of a traffic stream, A Traffic Destination which defines the termination of a traffic stream, A Traffic Handling Element, which is that part of the telecommunications network that has conveyed contents of a traffic stream from a source to a destination. Examples of Traffic Stream Types are chosen from the group of: Data traffic Voice traffic SMS traffic MMS traffic Electronic mail traffic.

### TECHNICAL FIELD OF THE INVENTION

The present invention discloses a method for monitoring service performance and quality level in a telecommunications network. By means of the invention, such monitoring is improved as compared to existing methods.

### STATE OF THE ART

A telecom service provider wants to monitor the service performance and quality level in his network in order to, inter alia:
Prove compliance with service level agreements
Make refunds in case of violations of said agreements
Be able to maintain a service level objective
Identify and address resource problems
Monitor service usage to plan and optimize resources.

The way in which the service performance and quality level in a telecom network is measured may vary. Usually, there exists a variety of so called observed objects with related KPI:s (Key Performance Indicators) which can be used in the monitoring of a certain telecom service. A service model is defined in order to describe the relationship between the observed objects and the service. Also, the relationships between the KPI:s for the observed objects and the KQI:s (Key Quality Indicators) for the services are expressed in the service model.

An issue here is how to select the observed objects and to define the service model. One known approach is based on the fact that the telecom service and its quality is dependent on several components, elements and resources in the telecom network. The monitoring of service performance and quality level may then be based on a hierarchy of these components, elements and resources, since they are already monitored by existing fault and/or management networks.

In order to measure service performance and quality level based on the monitoring of resources, the relationship between the resources of the telecommunication network and the service level of the network need to be described in impact relationships in the service model, which can be difficult, especially if the telecom service provider wants to monitor service performance and quality level per user/subscriber, groups of users/subscribers or other source/destination aspects like geographical area or application.

### SUMMARY OF THE INVENTION

As described above, there is a need for a method for use in a telecommunications network which can enable the measurement and calculation of service performance and quality level in an easier and more precise way then previously known methods.

This need is addressed by the present invention by means of a method which defines so called Traffic Streams, which are used as the objects to be observed based on which service performance and quality level can then be calculated more easily and precisely than previous calculations which have used network resources as the observed objects.

A Traffic Stream as an object comprises:
A Traffic Stream Type, which defines the nature of the traffic stream,
A Traffic Source, which defines the origin of the traffic stream,
A Traffic Destination which defines the termination of a traffic stream,
A Traffic Handling Element, which is that part of the telecommunications network which has conveyed the contents of a traffic stream from a source to a destination.

Examples of Traffic Stream Types are chosen from the group of:
Data traffic,
Voice traffic,
SMS traffic,
MMS traffic,
Electronic mail traffic,
Video Traffic.
Any combination of the previous examples.

By means of the method according to the invention, an easy and efficient way of measuring and monitoring service performance and quality level in a telecommunications network is obtained, as will become apparent from the following detailed description.

### BRIEF DESCRIPTION OF THE DRAWINGS

The invention will be described in more detail in the following, with reference to the appended drawings, in which

FIG. 1 shows definitions of types used in the method according to the invention, and

FIG. 2 shows components in a Traffic Stream in the method according to the invention.

### EMBODIMENTS

As stated above, a Traffic Stream as defined by the invention comprises a Traffic Stream Type, a Traffic Source, a Traffic Destination and a Traffic Handling Element. In order to facilitate the understanding of the principles behind the invention, some examples of the elements comprised in a Traffic Stream will be given below, followed by an example of how the invention is used.

It should be pointed out that the list of examples given below is non-exhaustive, its intention is merely to highlight some principles of the invention.

A Traffic Handling Element is an identifiable logical or physical element/entity which handles traffic in a telecommunications network. Some examples of such elements are:
exchanges,
switches,
routers,
servers,
MMS-centers,
SMS-centers,
A streaming server,
A web server
A video gateway
A cluster or a network of any of the above

A Traffic Source is an identifiable source of traffic in a telecommunications network. Some examples are:
A specific telephone number,
A truncated telephone number, e.g. a number which identifies a switchboard in, for example, a specific factory, hotel etc,
A specific Internet URI,
A truncated Internet URI,
A set of any of the Traffic Sources above.

A Traffic Destination is an identifiable destination of traffic in a telecommunications network. Some examples are:
A specific telephone number,
A truncated telephone number,
A specific Internet URI,
A truncated Internet URI,
A set of any of the Traffic Destinations above.

A Traffic Stream Type is an identifiable type of Traffic Stream within a Traffic Type in a telecommunications network, some examples of which are:
Circuit switched voice
Voice over IP
SMS
MMS
PoC (Push to talk over Cellular)

Since the invention makes use of Traffic Streams as defined above, monitoring of traffic between specified points in the network can be easily achieved. Thus, a telecom operator can, using the invention, monitor the traffic between more or less any two points in his network, and can thus easily get input for calculations of the service performance and quality level for a specified telecom service and/or for a specified customer or customer segment.

In order to facilitate the understanding of the invention, an example will be given which makes use of MMS-traffic. (Multimedia Messaging Service). However, it should be understood that the invention is not limited to MMS, the method according to the invention can be applied to virtually any type of traffic in a telecommunications network.

The example will be given as a series of steps which are taken in order to arrive at a telecommunications monitoring system in which the invention may be applied.

Thus, the description below will initially outline a telecommunications monitoring system network within which the invention may be applied, following which an example of the invention as such will be described.

It should be realized that the steps need not be taken in the order that they are described below, and that many of the steps can be carried out simultaneously.

Steps for Type Definitions

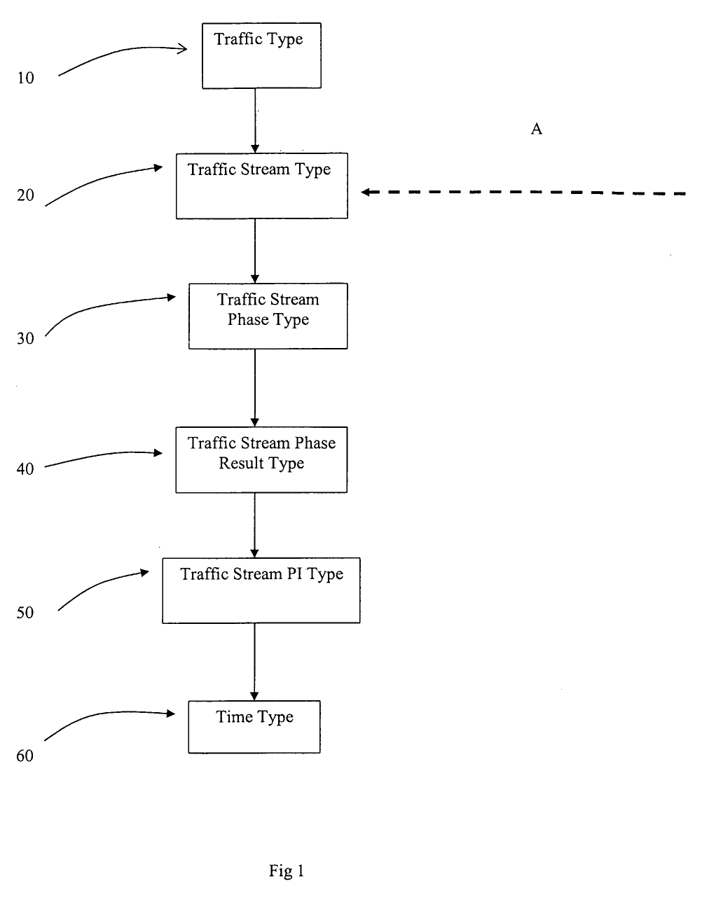

With reference to FIG. 1, the first step which is taken is to define which Traffic Type (block 10) that is to be monitored. The Traffic Type can be virtually any kind of traffic in the network, but the type used in this example will be MMS (Multimedia Messaging Service). Other examples of traffic which can be mentioned are voice, SMS (Short Messaging Service), data and video.

The next step (not shown in FIG. 1) is to define which Traffic Handling Element Types that will be involved in the monitoring. Since the Traffic Type that is to be monitored in the example is MMS, the Traffic Handling Elements will be Handling Elements that can handle MMS-traffic, more specifically the elements are suitably so called MMS-C:s, where the type defines such parameters as manufacturer, version, etc. The parameters in the type should be such that the kind of MMS-C can be identified unambiguously.

Another parameter which needs to be defined within a Traffic Type is the Traffic Stream Type (block 20 in FIG. 1). A Traffic Stream Type can be defined by its Traffic Source Type, Traffic Destination Type and Handling Element Type. As an example, in the case of MMS-traffic, the Traffic Stream Type can be MO-MT (Mobile Originating, Mobile Terminating).

Within each Traffic Stream Type, there can be several Phase Types (block 30 in FIG. 1), which also need to be defined. Example of valid Traffic Stream Phase Types for MMS-traffic between two mobile terminals are “Send”, “Notification” and “Delivery.

Within each Traffic Stream Phase Type, valid Result Types (block 40 in FIG. 1) also need to be defined. Examples of such types are OK and NOK (Not OK),

The Performance Indicator Type (block 50 in FIG. 1) also needs to be defined, said type also being referred to as the PI-type. Examples of valid values for this type are the number of transactions to counted, the delay between two transactions, the standard deviation for the delay times, etc.

Finally, the measurement updating time type for each PI also needs to be defined, the type being referred to as the Time Type (block 60 in FIG. 1). Examples of such updating time types are every 15 minutes, hourly, daily, weekly, etc.

The preceding description has concentrated on describing a network in which the invention may be used. Thus, those parts, types etc which have been described hitherto in this chapter are not necessarily a part of the invention, but rather a context in which the invention can be used.

Traffic Stream Definition

When one wishes to use the method according to the invention, one or more Traffic Streams as described above are defined for the monitoring according to the invention.

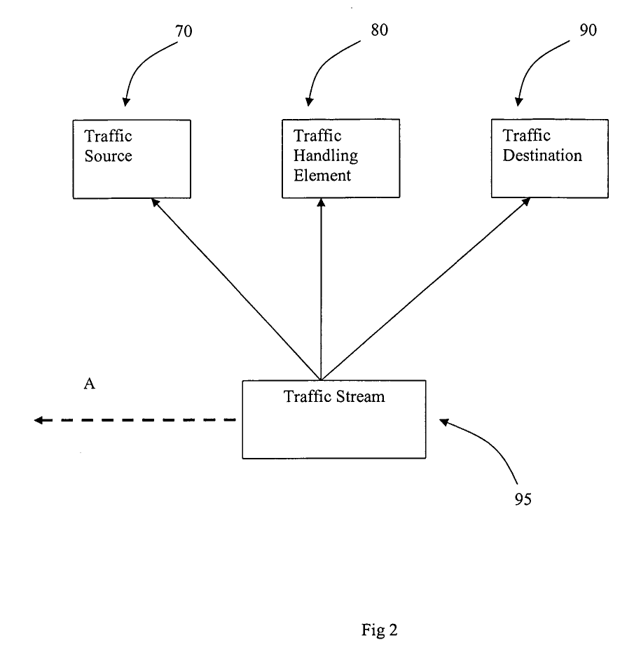

Thus, each Traffic Stream (shown as block 95 in FIG. 2) that is defined for monitoring will comprise:
A Traffic Stream Type, which defines the nature of the traffic stream, which explains the arrow “A” which connects the Traffic Stream Type of block 20 in FIG. 1 to block 95 of FIG. 2,
A Traffic Source, which defines the origin of a traffic stream, (shown as block 70 in FIG. 2),
A Traffic Destination which defines the termination of a traffic stream, (shown as block 90 in FIG. 2)
A Traffic Handling Element (shown as block 80 in FIG. 2), which is that part of the telecommunications network that has conveyed contents of a traffic stream from a source to a destination.

When defining Traffic Streams to be monitored according to the invention, the Traffic Handling Elements which are to be observed are one of the items that are defined, in this case as tangible elements or components in the network. Thus, in the case of MMS-traffic, an example of Traffic Handling Elements over which traffic might be monitored would be “MMS-C-1” and “MMS-C-2”. This is in contrast to defining Handling Element Types, where what was defined was the kind of MMS-C, i.e. manufacturer, version, etc.

In addition, the Traffic Sources and Traffic Destinations which are to be included in the Traffic Stream which is to be observed are also defined. As an example, it could be possible to define the Source and Destination as “all MO-MT MMS-traffic from Company A (source) to Company B (destination)”.

Traffic Stream Performance Indicator (PI) Measurement

When there are Traffic Streams which have been defined as shown and which are to be observed, the measurement of the Traffic Stream PI:s can commence. For each measured PI-value, a time stamp is attached to the value.

The exact nature of the monitoring will naturally depend on the nature of the PI which it is desired to measure, and will for that reason not be describe in detail here. In addition, the PI:s which are foreseen to be measured at present are well known to those skilled in the art.

The measurement data can be generated in various ways, such as:
Non-intrusive probes,
Transaction/detailed record log parsing,
Test robots.

Following the generation of measured data, the data can be refined so that the desired PI:s are arrived at.

Thus, in conclusion, the method of the invention provides a comfortable, easy and precise way for an operator of a telecommunications network to monitor and measure virtually any kind of traffic between any two or more points in the network. This might be necessary in order to, for example, prove to a customer that the service level provided has reached a level agreed upon.

1. A method for monitoring service performance and quality level in a telecommunications network, characterized in that the method comprises the use of Traffic Streams as the objects which are observed and used for said monitoring; the Traffic Streams being defined as objects which comprise:
A Traffic Stream Type, which defines the nature of the traffic stream,
A Traffic Source, which defines the origin of a traffic stream,
A Traffic Destination which defines the termination of a traffic stream,
A Traffic Handling Element, which is that part of the telecommunications network that has conveyed contents of a traffic stream from a source to a destination.

2. The method according to claim 1, in which the Traffic Stream Type is chosen as one or several from the group of:
Data traffic,
Voice traffic,
SMS traffic,
MMS traffic,
Electronic mail traffic,
Video traffic.
